(19) United States
(12) Patent Application Publication
(10) Pub. No.: US 2003/0105627 A1
(43) Pub. Date: Jun. 5, 2003

(54) Method and apparatus for converting linear predictive coding coefficient to reflection coefficient

(76) Inventor: Shih-Chien Lin, Taipei (TW)

Correspondence Address: HOWREY SIMON ARNOLD & WHITE LLP, BOX 34, 1299 PENNSYLVANIA AVENUE NW, WASHINGTON, DC, 20004, US

(21) Appl. No.: 09/991,972

(22) Filed: Nov. 26, 2001

(51) Int. Cl. G10L 19/10; G10L 19/08

(52) U.S. Cl. 704/219

(57) ABSTRACT

A speech coder and a method for speech coding for optimizing computing efficiency in a speech compression process. The present invention increases computing efficiency in speech coders that perform conversions of linear predictive coding coefficients to reflection coefficients. Specifically, the invention removes a division operation from a recursive calculation within a the conversion process in a mixed excitation linear prediction decoder. As a result, less power is consumed and fewer clock cycles are required to run.

### BACKGROUND OF THE INVENTION

1. Field of the Invention

This invention relates to a method and apparatus for speech processing, and more specifically to a speech coder and a method of speech coding for optimizing computing efficiency in a speech compression process.

2. Related Art

Speech compression, which is also known as speech coding, is a technique that reduces the amount of data to be transmitted for communication or storage. More specifically, it is a method for compressing the digital representation of speech signals, thereby reducing the number of bits that represent the speech signals. It has many practical applications in the digital transmission and digital storage of speech signals. For example, in digital transmission, speech compression is used in applications such as mobile radio, cellular telephone technology, and secure voice systems. By compressing the speech in these applications, more users can use the systems than otherwise would be possible. In the area of digital storage of speech signals, speech compression is used in applications such as digital answering machines and voice response systems. For example, in a digital answering machine, speech compression of the signals allows for the storage of longer messages than otherwise possible.

Linear predictive coding (LPC) is a method of compression that models the process of speech production. Specifically, LPC is a digital method used to predict speech samples by use of a linear combination of previous speech samples. In human speech, sound is produced in the vocal tract, which may be described as a tube having a variable diameter, or a series of tubes, each tube having a variable diameter. The LPC model is based on a mathematical approximation of this variable-diameter tube or tubes.

The algorithm for LPC involves an encoding process and a decoding process. In the encoding process, the speech coder system determines a set of parameters that model the vocal tract during the production of a given speech signal. In the decoding process, the speech coder system uses the parameters from the encoding process to build a synthesized version of the original speech signal. The decoder uses a filter to recreate the original signal, and the filter is based on a set of coefficients. These coefficients, or prediction coefficients, are taken from the original signal during the encoding process and are transmitted to the receiver for use during decoding.

During the decoding process, parameters called reflection coefficients are generated. These coefficients are derived from the LPC coefficients. A reflection coefficient represents the angle of reflection of a sound wave. When a wave arrives at a boundary between two tubes having different diameters, the wave does not simply transmit through the tube. Instead, parts of the wave are reflected from the boundary. The angle of incidence of the sound wave on the boundary equals the angle of reflection.

In known methods and apparatuses for speech compression, a mixed excitation linear prediction (“MELP”) decoder may be used to decode speech signals. The MELP uses a division operation within a recursive loop in the conversion of LPC coefficients to reflection coefficients. Division operations, however, are difficult to process. That is, they consume much power and require many clock cycles to run. When division operations are run in recursive loops, because the loops repeat, even more computing power and clock cycles are required.

Therefore, it is an object of the present invention to increase computing efficiency in speech coders that perform LPC coefficients to reflection coefficients conversions and methods of doing the same.

### SUMMARY OF THE INVENTION

In accordance with the invention, there is provided a speech coder for compressing a speech signal.

In an embodiment of the invention, the speech coder receives a predictor coefficient as input, stores the predictor coefficient in a first temporary storage buffer, determines a reflection coefficient from the predictor coefficient stored in the first temporary storage buffer, calculates a multiplication factor, recursively calculates a numerator and multiplies the numerator by the multiplication factor, and stops the recursive calculation after it has been performed a predetermined number of times. In this embodiment, the multiplication factor is determined outside the recursive calculation.

In another preferred arrangement, the speech coder calculates the numerator by use of the following equation: temp=(b1[j]−k[i]*b1[i−j]), where i is an integer value, j is an integer value, temp is a second temporary storage buffer for storing the numerator, b1[j] is a third temporary storage buffer for storing values of the first temporary storage buffer, and b1[i−j] is a fourth temporary storage buffer for storing values of the first temporary storage buffer.

In another preferred arrangement of this embodiment, the speech coder determines the reflection coefficient by amplifying the predictor coefficient stored in the first temporary storage buffer.

In yet another preferred arrangement, the speech coder calculates the multiplication factor by determining a denominator.

In still yet another preferred arrangement, the speech coder further amplifies the denominator to its largest and most accurate value.

In another preferred arrangement, the speech coder further performs a fixed-point division operation using the denominator.

In another preferred arrangement, the speech coder performs the fixed-point division operation by taking an inverse of the denominator.

In yet another preferred arrangement, the speech coder takes the inverse of the denominator by use of the following equation: Divd=0x4000/n_e, where Divd represents the multiplication factor, 0x4000 is the hexadecimal representation of 0.5, and n_e is the denominator, which represents a normalized and amplified value of a residue of the signal.

In another preferred arrangement, the speech coder further amplifies the multiplied numerator and multiplication factor.

There is also provided a method of speech coding which includes the steps of receiving a predictor coefficient, storing the predictor coefficient in a first temporary storage buffer, determining a reflection coefficient from the predictor coefficient stored in the temporary storage buffer, calculating a multiplication factor, recursively calculating a numerator and multiplying the numerator by the multiplication factor, and stopping the recursive calculation after it has been performed a predetermined number of times. In this method, the multiplication factor is determined outside the recursive calculation.

A preferred method includes calculating the numerator by using the following equation: temp=(b1[j]−k[i]*b1[i−j]), where i is an integer value, j is an integer value, temp is the second temporary storage buffer for storing the numerator, b1[j] is a third temporary storage buffer for storing values of the first temporary storage buffer, and b1[i−j] is a fourth temporary storage buffer for storing values of the first temporary storage buffer.

Another preferred method of speech coding includes the step of determining the reflection coefficient by amplifying the predictor coefficient stored in the first temporary storage buffer.

Yet another preferred method includes the step of calculating the multiplication factor by determining a denominator.

Still another preferred method further includes amplifying the denominator to its largest and most accurate value.

Yet another preferred method includes performing a fixed-point division operation using the denominator.

Another preferred method includes performing the fixed-point division operation by taking an inverse of the denominator.

Yet another preferred method includes taking the inverse of the denominator by using the following equation: Divd=0x4000/n_e, where Divd represents the multiplication factor, 0x4000 is the hexadecimal representation of 0.5, and n_e is the denominator, which represents a normalized and amplified value of a residue of the signal.

Another preferred method further includes amplifying the multiplied numerator and multiplication factor.

Also, there is provided a method of speech coding for compression of a speech signal, which includes the steps of receiving a predictor coefficient as input, storing the predictor coefficient in a first temporary storage buffer, determining a reflection coefficient from the predictor coefficient stored in the first temporary storage buffer, calculating a multiplication factor from a denominator, where the multiplication factor is defined by the equation: Divd=0x4000/n_e, where Divd is the multiplication factor, 0.4000 is a hexadecimal representation of 0.5, and n_e is the denominator, which represents a normalized and amplified value of a residue of the signal. The method also includes the steps of recursively calculating a numerator and multiplying the numerator by the multiplication factor, where the numerator is defined by the equation: temp=(b1[j]−k[i]*b1[i−j]), where i is an integer value, j is an integer value, temp is the second temporary storage buffer, for storing the numerator, b1[j] is a third temporary storage buffer, for storing values of the first temporary storage buffer, and b1[i−j] is a fourth temporary storage buffer, for storing values of the first temporary storage buffer; and stopping the recursive calculation after it has been performed a predetermined number of times, where the multiplication factor is determined outside the recursive calcualtion.

In a preferred method, the step of determining the reflection coefficient includes amplifying the predictor coefficient stored in the first temporary storage buffer.

In yet another preferred method, the method further includes amplifying the multiplied numerator and multiplication factor.

In another embodiment of the invention, the speech coder includes a predictor coefficient that is received as input, a first temporary storage buffer, where the first temporary storage buffer stores the predictor coefficient, a reflection coefficient determined from the predictor coefficient stored in the first temporary storage buffer, a multiplication factor, and a numerator, where the numerator is recursively calculated and multiplied by the multiplication factor, the recursive calculation is stopped after it has been performed a predetermined number of times, and the multiplication factor is determined outside the recursive calculation.

In another preferred arrangement, the numerator is defined by the following equation: temp=(b1[j]−k[i]*b1[i−j]), where i is an integer value, j is an integer value, temp is a second temporary storage buffer for storing the numerator, b1[j] is a third temporary storage buffer for storing values of the first temporary storage buffer, and b1[i−j] is a fourth temporary storage buffer for storing values of the first temporary storage buffer.

In another preferred arrangement of this embodiment, the reflection coefficient is determined by amplification of the predictor coefficient stored in the first temporary storage buffer.

In yet another preferred arrangement, the multiplication factor includes a denominator.

In still yet another preferred arrangement, the denominator is amplified to its largest and most accurate value.

In another preferred arrangement, the denominator is used to perform a fixed-point division operation.

In another preferred arrangement, the fixed-point division operation includes taking an inverse of the denominator.

In yet another preferred arrangement, the inverse of the denominator is defined by the following equation: Divd=0x4000/n_e, where Divd represents the multiplication factor, 0x4000 is the hexadecimal representation of 0.5, and n_e is the denominator, which represents a normalized and amplified value of a residue of the signal.

In another preferred arrangement, the multiplied numerator and multiplication factor are amplified.

Other systems, methods, features and advantages of the invention will become apparent to one skilled in the art upon examination of the following figures and detailed description. It is intended that all such additional systems, methods, features, and advantages be included within this description, be within the scope of the invention, and be protected by the accompanying claims.

### DESCRIPTION OF THE DRAWINGS

FIG. 1 is a block diagram of a computer system that provides the operating environment for an illustrative embodiment of the present invention.

FIG. 2 is a flowchart illustrating steps of a conventional method for speech compression.

FIG. 3A is a block diagram of a speech coder system that provides the operating environment for an illustrative embodiment of the present invention; FIG. 3B is a flowchart illustrating steps of a method for speech compression.

### DETAILED DESCRIPTION OF THE PREFERRED EMBODIMENTS

The detailed description that follows is presented largely in terms of algorithms and symbolic representations of operations on data bits and data structures within a computer memory. These algorithmic descriptions and representations are the means used by those skilled in the data processing arts to most effectively convey the substance of their work to others skilled in the art.

An algorithm is here, and generally, conceived to be a sequence of steps leading to a desired result. Usually, though not necessarily, these quantities take the form of electrical or magnetic signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities are merely convenient labels applied to these quantities.

Further, the manipulations performed are often referred to in terms, such as adding and comparing that are commonly associated with mental operations performed by a human operator. No such capability of a human operator is necessary, or desirable in most cases, in any of the operations described herein that form part of the present invention. The operations are machine operations. Useful machines for performing the operations of the present invention include personal computers, hand-held devices, multiprocessor systems, microprocessor-based or programmable consumer electronics, minicomputers, mainframe computers, and the like. It should be noted that in all cases, there is a distinction between the method of operation in operating a computer and the method of computation itself. The present invention relates to method steps for operating a computer in processing electrical or other physical signals to generate other desired physical signals.

The present invention also relates to an apparatus for performing these operations. This apparatus may be specifically constructed for the required purposes, or it may be a general-purpose computer as selectively activated or reconfigured by a computer program stored in the computer. The algorithms presented herein are not inherently related to any particular computer or other apparatus. In particular, various general purpose machines may be used with programs written in accordance with the teachings herein, or it may prove more convenient to construct a more specialized apparatus to perform the required method steps. The required structure for a variety of these machines will appear from the description given below.

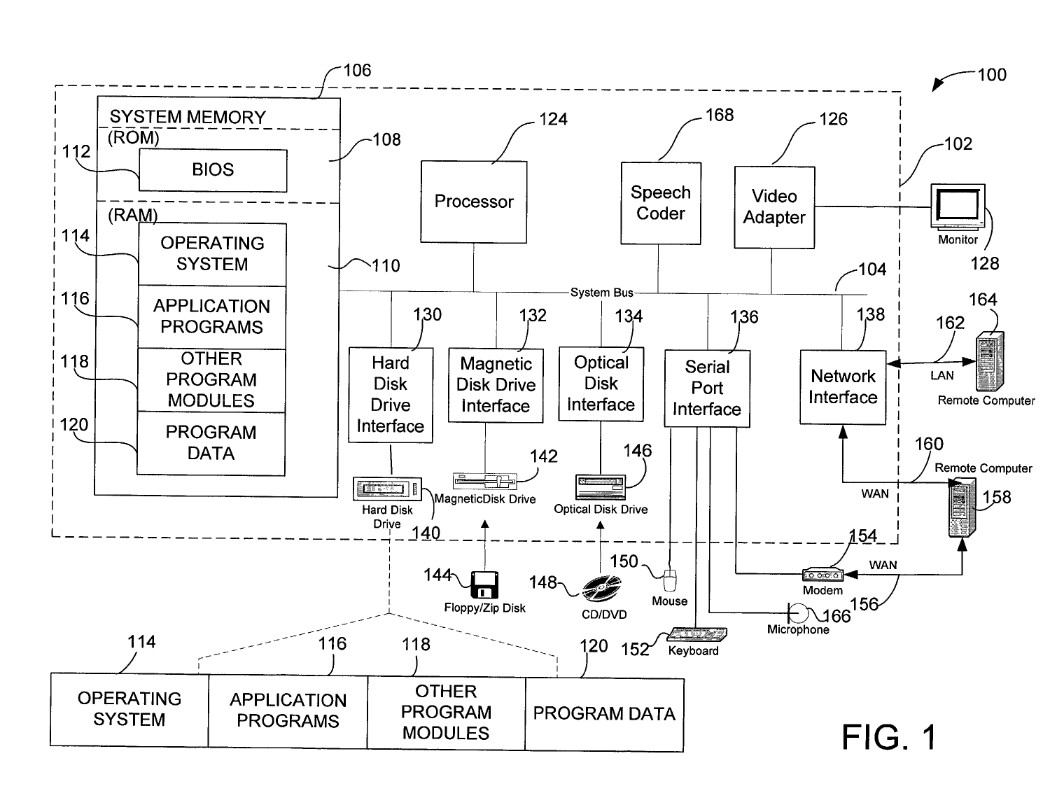

Turning now to the figures, FIG. 1 and the following discussion are intended to provide a brief, general description of a suitable computing environment in which the invention may be implemented. While the invention will first be described in the general context of an application program that runs on an operating system in conjunction with a personal computer, those skilled in the art will recognize that the invention also may be implemented in combination with other program modules. Generally, program modules include routines, programs, components, data structures, etc. that perform particular tasks or implement particular abstract data types. Moreover, those skilled in the art will appreciate that the invention may be practiced with other computer system configurations, including hand-held devices, multiprocessor systems, microprocessor-based or programmable consumer electronics, minicomputers, mainframe computers, and the like. The invention may also be practiced in distribution computing environments where tasks are performed by remote processing devices that are linked through a communications network. In a distributed computing environment, program modules may be located in both local and remote memory storage devices.

With reference to FIG. 1, an illustrative system for implementing the invention includes a conventional personal computer 102, including a processor 124, a system memory 106, and a system bus 104. The system bus 104 couples the system memory to the processor 124. The system memory 106 includes read only memory (ROM) 108 and random access memory (RAM) 110. A basic input/output system 112 (BIOS), containing the basic routines that help to transfer information between elements within the personal computer 102, such as during start-up, is stored in ROM 108. The personal computer 102 further includes a local hard disk drive 140, a magnetic disk drive 142, for reading from or writing to a removable disk, and an optical disk drive 146, for reading a CD-ROM disk 146, or for reading from or writing to other optical media. The hard disk drive 140, the magnetic disk drive 142, and the optical disk drive 146 are connected to the system bus 104 by a hard disk drive interface 130, a magnetic disk drive interface 132, and an optical disk drive interface 134, respectively. The drives and their associated computer-readable media provide nonvolatile storage for the personal computer 102. Although the description of computer-readable media above refers to a hard disk, a removable magnetic disk, and a CD-ROM disk, those skilled in the art will appreciate that other types of media which are readable by a computer, such as magnetic cassettes, flash memory cards, digital video disks, Bernoulli cartridges, and the like may also be used in the illustrative operating environment of FIG. 1.

A number of program modules may be stored in the drives and RAM 110, including an operating system 114, one or more application programs 116 (e.g., word processor applications, spreadsheet applications, and presentation applications), other program modules 118 (e.g., a speech recognition engine and/or a voice recognition engine), and program data 120. The program data 120 on local hard disk drive 140 may constitute speech data used in connection with the speech recognition engine and/or the voice recognition engine.

A user of computer 102 may enter commands and information into the personal computer 102 through a keyboard 152, a microphone 166, and a pointing device, such as a mouse 150. Other input devices (not shown) may include a joystick, satellite dish, scanner, or the like. These and other input devices are often connected to the processor 124 through a serial port interface 136 that is coupled to the system bus, but may be connected by other interfaces, such as a game port, a microphone input, or a universal serial bus (USB). A monitor 128 or other type of display device is also connected to the system bus 104 via an interface, such as a video adapter 126. In addition to the monitor, personal computers typically include other peripheral output devices (not shown), such as speakers or printers. A speech coder 168 is also coupled to the system bus.

The personal computer may operate in a networked environment using logical connections to one or more remote computers, such as remote computers 158 and 164. The remote computers 158 and 164 may be servers, routers, peer devices, or other common network nodes, and the remote computers 158 and 164 typically include many or all of the elements described relative to the personal computer 102. The logical connections to computers 158 and 164 depicted in FIG. 1 include a local area network (LAN) 162 and wide area networks (WAN) 156 and 160. Such networking environments are commonplace in offices, enterprise-wide computer networks, intranets, and the Internet.

When used in a LAN networking environment, the personal computer 102 is connected to the LAN 162 through a network interface 138. When used in a WAN networking environment, the personal computer 102 typically includes a modem 154 or other means for establishing communications over the WAN. The modem 154, which may be internal or external, is connected to the system bus 104 via the serial port interface 136. A WAN connection may also be made through the network interface 138 to WAN 156. In a networked environment, program modules depicted relative to the personal computer 102, or portions thereof, may be stored in the remote memory storage device. Particularly, each remote computer 158 and 164 and their respective storage devices (not shown) can be searchable information repositories. Those of ordinary skill in the art will appreciate that the network connections shown are illustrative, and other means of establishing a communications link between the computers may be used.

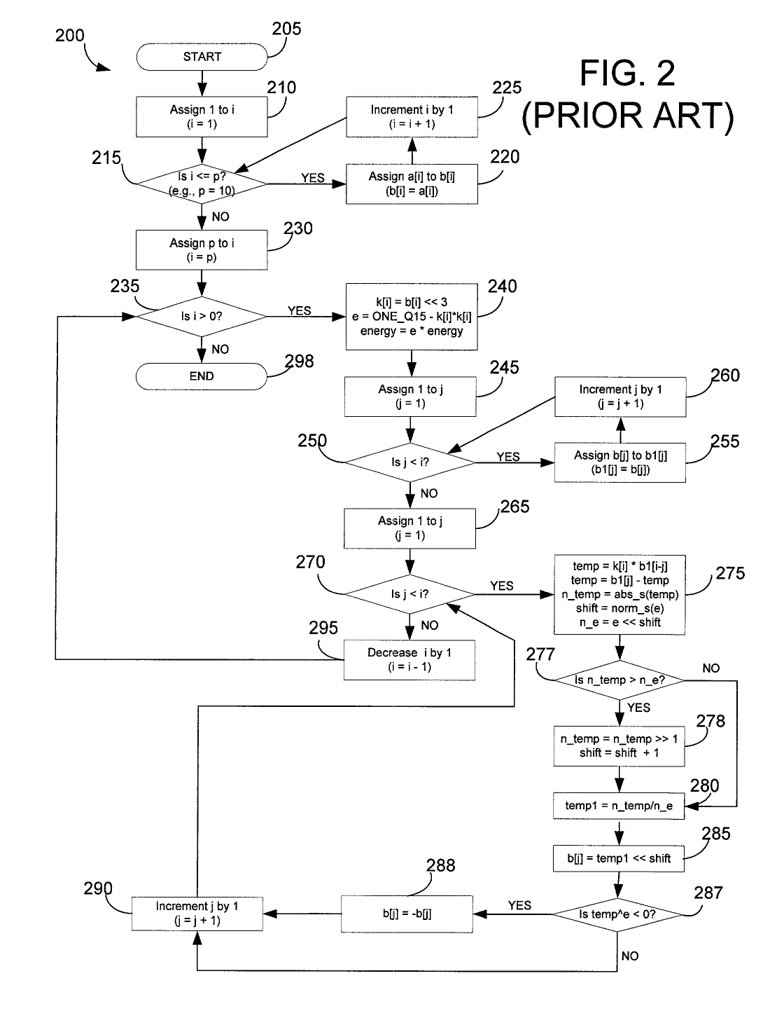

FIG. 2 shows a block diagram of a conventional method for speech compression. As shown in FIG. 2, the method 200 begins at start step 205 and proceeds to step 210. In step 210, the variable i is initialized. That is to say, a value of 1 is assigned to the variable i.

Next, in step 215, an evaluation of the condition i<=p occurs. The method 200 determines whether i is less than or equal to p, where p represents the predictor order. The value of p may range from 0 to an infinite integer value. For this implementation, a 10 order value is chosen. If i is less than or equal to p, then the method 200 proceeds to step 220 and executes the statement that assigns the linear predictor coefficient, a[i], to temporary storage buffer b[i]. After the execution statement in step 220, i is incremented in step 225, and the method 200 loops back to step 215 and checks the condition again. This loop continues until the condition evaluates to false, at which point the method 200 proceeds to step 230, where the variable i is re-initialized. That is to say, the value of p, or 10 in this example, is assigned to i.

Next, the method 200 proceeds to determine the reflection coefficients. First, in step 235, the evaluation of the condition i>0 occurs. The method 200 determines whether i is greater than 0, and if i is greater, then the method 200 proceeds to step 240. In step 240, mathematical manipulations are conducted to calculate the energy of a residual signal. The manipulations include amplifying the value stored in the temporary storage buffer b[i], which contains the value of the predictor coefficient a[i], so as to obtain the reflection coefficient k[i]. The reflection coefficient k[i] is then used to calculate the residual signal e. In addition, the variable ONE_Q15, which is approximately equal to 1 in Q15 format representation, is used in the calculation. The energy of the residual signal e is calculated from the variable e. After the energy is calculated, the method 200 proceeds to step 245. There, the variable j is initialized to a value of 1.

The method 200 then proceeds to step 250, and the evaluation of the condition j<i occurs. If j is less than i, then in step 255, the value in the temporary storage buffer b1[j] is assigned to the temporary storage buffer b1[j]. Next, in step 260, the variable j is incremented by 1. After the execution of step 260, the method 200 loops back to step 250 and checks the condition again. This loop continues until the condition evaluates to false, at which point the method 200 proceeds to step 265, where the variable j is re-initialized to a value of 1.

After the execution of step 265, the method 200 proceeds to step 270. There, the evaluation of the condition j<i occurs. If j is less than i, then in step 275 through step 280, mathematical manipulations are conducted to solve the equation:

b[j]=(b1[j]−k[i]*b1[i−j])/n_{—}e. (1)

First, in step 275, the numerator (b1[j]−k[i]*b1[i−j]) is calculated. Before the fixed-point division operation, the method 200 must verify that both the numerator and the denominator are positive values and that the numerator is less than or equal to the denominator. As such, the method 200 takes the absolute value of the numerator to get a positive value and normalizes the denominator to get a positive value. A shift left operation is performed on the denominator, thereby amplifying it to its largest accuracy. The denominator must be greater than 4000H.

Next, in step 277, the method 200 evaluates the condition n_temp>n_e. If the numerator is greater than the denominator, then the method 200 proceeds to step 278 to perform a shift right operation on the numerator, which effectively compresses the numerator. This operation ensures that the numerator is less than or equal to the denominator. Also, the value of the variable shift is incremented in step 278. The method 200 then proceeds to step 280, which performs the fixed-point division operation of equation (1). If the numerator is not greater than the denominator, then the method 200 proceeds directly to step 280.

As shown in step 280, a division operation, which divides (b1[j]−k[i]*b1[i-j]) by n_e is performed. This division operation occurs within the recursive loop prompted by condition step 270. After the execution of step 280, the method 200 proceeds to step 285, where the temporary storage buffer temp1, which represents the numerator (b1[j]−k[i]*b1[i−j]), divided by the denominator n_e, is amplified. The result is stored in the temporary storage buffer b[j].

The numerator must be returned to a negative value if it started as a negative value. Therefore, in step 287, method 200 evaluates the condition tempˆ e<0. If the condition evaluates to true, then b[j] is negated. The method 200 then increments j by 1 in step 290, loops back to step 270, and checks the condition again. This loop continues until the condition evaluates to false, at which point the method 200 proceeds to step 295, where the variable i is decreased by 1.

After step 295, the method 200 loops back to step 235 and checks the condition i >0 again. This loop continues until the condition evaluates to false, at which point the method 200 ends at step 298.

The method 200 includes steps, which may be implemented in C programming language. An exemplary program that performs the steps of the conventional method 200 is provided after the specification and before the claims (see Part I of the Computer Program Listings).

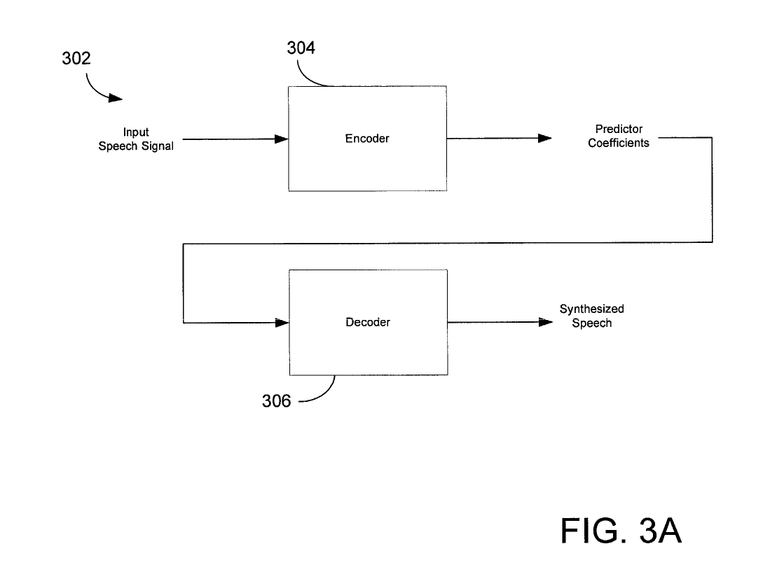

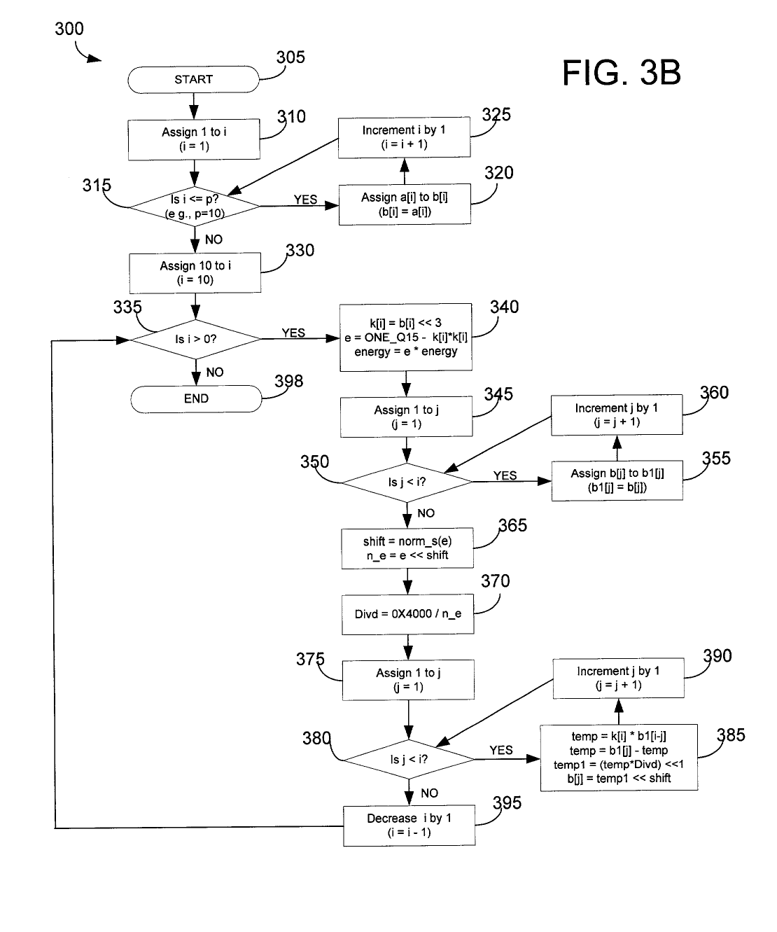

FIG. 3A is a block diagram of a speech coder system that provides the operating environment for an illustrative embodiment of the present invention. As shown in FIG. 3A, the speech coder system 302 includes an encoder 304 and a decoder 306. A speech signal is input into the encoder 304, and the encoder 304 determines parameters that model the speech signal. The predictor coefficients are a set of parameters that are output from the encoder 304. The decoder 306 receives the predictor coefficients as input, and uses the predictor coefficients to determine the reflection coefficients. The decoder 306 uses a filter to recreate the original signal, and the filter is based on the coefficients. The decoder 306 then outputs the synthesized speech.

FIG. 3B shows one method of implementing the present invention. As shown in FIG. 3B, the method 300 begins at start step 305 and proceeds to step 310. In step 310, the variable i is initialized. That is to say, a value of 1 is assigned to the variable i.

Next, in step 315, an evaluation of the condition i<=p occurs. The method 300 determines whether i is less than or equal to p, where p is the predictor order. For this implementation, a value of 10 has been chosen, but the value may be any integer from 0 to an infinite integer value. If i is less than or equal to 10, then the method 300 proceeds to step 320 and executes the statement that assigns the predictor coefficients, a[i], to temporary storage buffer b[i]. After the execution statement in step 320, i is incremented in step 325, and the method 300 loops back to step 315 and checks the condition again. This loop continues until the condition evaluates to false, at which point the method 300 proceeds to step 330, where the variable i is re-initialized, this time, to a value of p, which may be 10 in this implementation. Again the value of p may be replaced with another integer value.

Next, the method 300 proceeds to step 335, and the evaluation of the condition i>0 occurs. The method 300 determines whether i is greater than 0, and if i is greater, then the method 300 proceeds to step 340. In step 340, mathematical manipulations are conducted to calculate the energy of a residual signal. The manipulations include amplifying the value in the temporary storage buffer b[i], which contains the value of the predictor coefficient a[i], so as to obtain the reflection coefficient k[i]. The reflection coefficient k[i] is then used to calculate the energy of the residual signal e. In addition, the variable ONE_Q15, which is approximately equal to 1 in Q15 format, is used in the calculation. The energy of the residual signal e is calculated from the variable e. After the energy is calculated, the method 300 proceeds to step 345. There, the variable j is initialized to a value of 1. The method 300 then proceeds to step 350, and the evaluation of the condition j<i occurs. If j is less than i, then in step 355, the value in the temporary storage buffer b[j] is assigned to the temporary storage buffer b1[j]. Next, in step 360, the variable j is incremented by 1. After the execution of step 360, the method 300 loops back to step 350 and checks the condition again. This loop continues until the condition evaluates to false, at which point the method 300 proceeds to step 365 where the signal represented by the variable e is normalized and then amplified. The variable e is normalized because the denominator must be a positive value, and the denominator must be amplified to the largest accuracy. That is, the denominator must be greater than 4000H. In the next step 370, the method 300 calculates a multiplication factor, Divd. As shown in FIG. 3B, the multiplication factor is calculated using the following equation:

Divd=0x4000/n_{—}e. (2)

The 0x4000 value is a predetermined value that represents the hexadecimal representation for the decimal number 0.5. This factor is used to satisfy the requirements for a fixed-point division operation, such that the denominator, n_e, must be amplified to its largest most accurate value. After the calculation of the multiplication factor, the method 300 proceeds to step 375 where the variable j is initialized to a value of 1.

After the execution of step 375, the method 300 proceeds to step 380. There, the evaluation of the condition j<i occurs. If j is less than i, then in step 385, mathematical manipulations are conducted to solve the equation:

temp=(b1[j]−k[i]*b1[i−j])*Divd. (3)

This equation (3) calculates the temporary storage buffer temp, which stores the product of the numerator and the multiplication factor. In the numerator numerator (b1[j]−k[i]*b1[i−j]), i is an integer value, j is an integer value, b1[j] is a temporary storage buffer for storing values of the temporary storage buffer that stores the predictor coefficient, and b1[i−j] is a temporary storage buffer for storing values of the temporary storage that stores the predictor coefficient. As shown in step 385, this step does not include a division operation. That is to say, in the present invention, the division operation, which divides the numerator (b1[j]−k[i]*b1[i−j]) by the denominator n_e is not performed. The inverse of n_e is calculated outside the recursive loop prompted by condition step 380. Specifically, the inverse of n_e is calculated outside the recursive loop by equation (2), which calculates Divd. In step 385, the numerator (b1[j]−k[i]*b1[i−j]) is calculated and stored in the temporary storage buffer temp. Then the numerator is multiplied by the inverse of the denominator, which is the multiplication factor Divd. A shift left operation is performed on the product, thereby multiplying the product by 2, so as to compensate for the 0.5 multiplication factor used in the calculation of Divd. After the execution of step 385, the method 300 proceeds to step 390, where j is incremented by 1. The method 300 loops back to step 380 and checks the condition again. This loop continues until the condition evaluates to false, at which point the method 300 proceeds to step 395, where the variable i is decreased by 1.

After step 395, the method 300 loops back to step 335 and checks the condition i>0 again. This loop continues until the condition evaluates to false, at which point the method 300 ends at step 398.

The present invention removes a division operation from a recursive calculation within the conversion process in a mixed excitation linear prediction decoder. As a result, less power is consumed and fewer clock cycles are required to run.

The method 300 includes steps, which may be implemented in C programming language. An exemplary program that performs steps that implement the method 300 is provided after the specification and before the claims (see Part II of the Computer Program Listings).

While various embodiments of the present invention have been described, it will be apparent to those of ordinary skill in the art that many more embodiments and implementations are possible that are within the scope of this invention. Accordingly, the invention is not to be restricted except in light of the attached claims and their equivalents.

COMPUTER PROGRAM LISTINGS

I. EXEMPLARY PROGRAM OF THE PRIOR ART
/*_{——————————————————————————————————————}
_{————}
|

| | |
|---|---|
| \| | NAME: 1pc_pred2refl_bak( ) ( original code ) |

|

| | |
|---|---|
| \| | get reflection coefficients from the predictor coefficients |

| | |
|---|---|
| \| | Input: |

| | |
|---|---|
| \| | a - the predictor coefficients Q12 |
| \| | p - the predictor order Q15 |

| | |
|---|---|
| \| | Output: |

| | |
|---|---|
| \| | k - the reflection coefficients |

| | |
|---|---|
| \| | Returns: |

| | |
|---|---|
| \| | energy - energy of residual signal Q15 |

|_{——————————————————————————————————————}
_{————}
*/
Shortword 1pc_pred2refl_bak(Shortword *a, Shortword *k, Shortword p)
{

Shortword b[11], b1[11], e;
Shortword energy = ONE_Q15;
Shortword i, j;
Shortword shift;
Shortword temp, temp1, n_temp, n_e;
//==== equate temporary variables (b = a) ====
for(i=1; i <= p; i++)
{

b[i] = a[i]

}
//==== compute reflection coefficients ====
for(i=p; i > 0; i−−)
{

k[i] = sh1(b[i],3); // Q12 −> Q15

e = sub(ONE_Q15,mult(k[i],k[i]));
energy = mult(energy,e);
for(j=1; j < i; j++)

{
b1[j] = b[j];
}

//==== b[j] = (b1[j] − k[i]*b1[i−j])/e ====

for(j=1; j < i; j++)

{
//==== b[j] = (b1[j] − k[i]*b1[i−j]) ====

temp = mult(k[i],b1[i−j]);
temp = sub(b1[j],temp); //calculate numerator

//==== check signs of temp and e before division ====
//(before fix-point division operation, must verify that both the

// numerator and denominator are positive values, and
numerator <= denominator)

| | |
|---|---|
| n_temp = abs_s(temp); | //take absolute value of |

// numerator to get a
// positive value

| | |
|---|---|
| shift = norm_s(e); | // normalize denominator |

// (denominator must be a
// positive value)

| | |
|---|---|
| n_e = shl(e, shift); | // amplify denominator to largest |

// accuracy; denominator
must be > 4000H

| | |
|---|---|
| if (n_temp > n_e) | // verify that |

numerator > denominator

{

n_temp = shr(n_temp,1);
shift = add(shift,1);

}

//calculate fixed-point division operation
n_temp/n_e

temp1 = divide_s(n_temp,n_e);
b[j] = sh1(temp1,shift); // b[j] in Q12

// return numerator to negative value if it started
as a negative value

if((temp\hat{ }e)<0) b[j] = negate(b[j]);

}
}

MEM_FREE(FREE,b1);
MEM_FREE(FREE,b);
return(energy);

}/* LPC_PRED2REFL_BAK */

II. EXEMPLARY PROGRAM OF THE PRESENT INVENTION
/*_{——————————————————————————————————————}
|

| | |
|---|---|
| \| | NAME: 1pc_pred2refl_k( ) (simplified code K; error rate 1 bit) |
| \| | |

| | |
|---|---|
| \| | get reflection coefficients from the predictor coefficients |

| | |
|---|---|
| \| | Input: |

| | |
|---|---|
| \| | a - the predictor coefficients Q12 |
| \| | p - the predictor order Q15 |

| | |
|---|---|
| \| | Output: |

| | |
|---|---|
| \| | k - the reflection coefficients |

| | |
|---|---|
| \| | Returns: |

| | |
|---|---|
| \| | energy - energy of residual Q15 |

|_{——————————————————————————————————————}
*/
Shortword 1pc_pred2refl_k (Shortword *a, Shortword *k)
{

Shortword b[11], b1[11];
Shortword energy = ONE_Q15;
Shortword i, j;
Shortword shift;
Shortword temp, temp1, n_temp, n_e;
//==== equate temporary variables (b = a) ====
for(i=1; i <= p; i++)
{

b[i] = a[i];

}
//==== Compute reflection coefficients ====
for(i=p; i > 0; i−−)
{

k[i] = shl(b[i],3);

e = sub(ONE_Q15, mult(k[i], k[i])); // e

energy = mult(energy,e); //energy=1−k[i]\hat{ }2

for (j=1; j<1; j++)
{
b1[j] = b[j];

}

shift = norm_s(n_e); // denominator must be a positive
value
n_e = shl(n_e, shift); // amplify denominator to the largest

// accuracy; denominator must
be > 4000H

divd = divide_s((short)0x4000,n_e); // inverse of

// denominator 0.5/n_e

//==== b[j]=(b1[j]−k[i]*b1[i−j]) * (1/e) ====
for(j=1;j<i;j++)
{
//==== (b1[j] − k[i] * b1[i−j]) ====
temp = mult(k[i], b1[i−j]);
temp = sub(b1[j], temp); // calculate numerator
//==== (numerator) * (inverse of denominator) * 2
temp1 = mult_sft(temp, divd, 1);
b[j] = shl(temp1, shift); // b[j] in Q12

}
return(energy);

} /* LPC_PRED2REFL_K */

What is claimed is:

1. A speech coder for compressing a speech signal, the speech coder comprising:
means for receiving a predictor coefficient as input;
means for storing the predictor coefficient in a first temporary storage buffer;
means for determining a reflection coefficient from the predictor coefficient stored in the first temporary storage buffer;
means for calculating a multiplication factor;
means for recursively calculating a numerator and multiplying the numerator by the multiplication factor; and
means for stopping the recursive calculation after it has been performed a predetermined number of times,
wherein the multiplication factor is determined outside the recursive calculation.

2. The speech coder of claim 1, wherein the means for calculating the numerator is defined by the equation:
temp=(b1[j]−k[i]*b1[i−j]),
wherein
i is an integer value;
j is an integer value;
temp is a second temporary storage buffer, for storing the numerator;
b1[j] is a third temporary storage buffer, for storing values of the first temporary storage buffer; and
b1[i−j] is a fourth temporary storage buffer, for storing values of the first temporary storage buffer.

3. The speech coder of claim 1, wherein the means for determining the reflection coefficient includes amplification of the predictor coefficient stored in the first temporary storage buffer.

4. The speech coder of claim 1, wherein the means for calculating the multiplication factor includes means for determining a denominator.

5. The speech coder of claim 4, further comprising means for amplifying said denominator to its largest and most accurate value.

6. The speech coder of claim 5, further comprising means for performing a fixed-point division operation using the denominator.

7. The speech coder of claim 6, wherein the means for performing the fixed-point division operation includes means for taking an inverse of the denominator.

8. The speech coder of claim 7, wherein the means for taking the inverse of the denominator is defined by the equation:
Divd=0x4000/n_{—}e,
wherein
Divd is the multiplication factor;
0x4000 is a hexadecimal representation of 0.5; and
n_e is the denominator, which represents a normalized and amplified value of a residue of the signal.

9. The speech coder of claim 8, further comprising means for amplifying the multiplied numerator and multiplication factor.

10. A method of speech coding for compression of a speech signal, the method comprising:
receiving a predictor coefficient as input;
storing the predictor coefficient in a first temporary storage buffer;
determining a reflection coefficient from the predictor coefficient stored in the first temporary storage buffer;
calculating a multiplication factor;
recursively calculating a numerator and multiplying the numerator by the multiplication factor; and
stopping the recursive calculation after it has been performed a predetermined number of times,
wherein the multiplication factor is determined outside the recursive calculation.

11. The method of claim 10, wherein the step of calculating the numerator includes solving the equation:
temp=(b1[j]−k[i]*b1[i−j]),
wherein
i is an integer value;
j is an integer value;
temp is the second temporary storage buffer, for storing the numerator;
b1[j] is a third temporary storage buffer, for storing values of the first temporary storage buffer; and
b1[i−j] is a fourth temporary storage buffer, for storing values of the first temporary storage buffer.

12. The method of claim 10, wherein the step of determining the reflection coefficient includes amplifying the predictor coefficient stored in the first temporary storage buffer.

13. The method of claim 10, wherein the step of calculating the multiplication factor includes determining a denominator.

14. The method of claim 13, further comprising amplifying said denominator to its largest and most accurate value.

15. The method of claim 14, further comprising performing a fixed-point division operation using the denominator.

16. The method of claim 15, wherein the step of performing the fixed-point division operation includes taking an inverse of the denominator.

17. The method of claim 16, wherein the step of taking the inverse of the denominator includes solving the equation:
Divd=0x4000/n_{—}e,
wherein
Divd is the multiplication factor;
0x4000 is a hexadecimal representation of 0.5; and
n_e is the denominator, which represents a normalized and amplified value of a residue of the signal.

18. The method of claim 17, further comprising amplifying the multiplied numerator and multiplication factor.

19. A method of speech coding for compression of a speech signal, the method comprising:
receiving a predictor coefficient as input;
storing the predictor coefficient in a first temporary storage buffer;
determining a reflection coefficient from the predictor coefficient stored in the first temporary storage buffer;
calculating a multiplication factor from a denominator, wherein the multiplication factor is defined by the equation:
Divd=0x4000/n_{—}e,
wherein
Divd is the multiplication factor;
0x4000 is a hexadecimal representation of 0.5; and
n_e is the denominator, which represents a normalized and amplified value of a residue of the signal;
recursively calculating a numerator and multiplying the numerator by the multiplication factor, wherein the numerator is defined by the equation:
temp=(b1[j]−k[i]*b1[i−j]),
wherein
i is an integer value;
j is an integer value;
temp is the second temporary storage buffer, for storing the numerator;
b1[j] is a third temporary storage buffer, for storing values of the first temporary storage buffer; and
b1[i−j] is a fourth temporary storage buffer, for storing values of the first temporary storage buffer; and
stopping the recursive calculation after it has been performed a predetermined number of times,
wherein the multiplciation factor is determined outside the recursive calculation.

20. The method of claim 19, wherein the step of determining the reflection coefficient includes amplifying the predictor coefficient stored in the first temporary storage buffer.

21. The method of claim 20, further comprising amplifying the multiplied numerator and multiplication factor.

22. A speech coder for compressing a speech signal, the speech coder comprising:
a predictor coefficient received as input;
a first temporary storage buffer, wherein the first temporary storage buffer stores the predictor coefficient;
a reflection coefficient determined from the predictor coefficient stored in the first temporary storage buffer;
a multiplication factor; and
a numerator,
wherein the numerator is recursively calculated and multiplied by the multiplication factor, the recursive calculation is stopped after it has been performed a predetermined number of times, and the multiplication factor is determined outside the recursive calculation.

23. The speech coder of claim 22, wherein the numerator is defined by the equation:
temp=(b1[j]−k[i]*b1[i−j]),
wherein
i is an integer value;
j is an integer value;
temp is a second temporary storage buffer, for storing the numerator;
b1[j] is a third temporary storage buffer, for storing values of the first temporary storage buffer; and
b1[i−j] is a fourth temporary storage buffer, for storing values of the first temporary storage buffer.

24. The speech coder of claim 22, wherein the reflection coefficient is determined by amplification of the predictor coefficient stored in the first temporary storage buffer.

25. The speech coder of claim 22, wherein the multiplication factor includes a denominator.

26. The speech coder of claim 25, wherein the denominator is amplified to its largest and most accurate value.

27. The speech coder of claim 26, wherein the denominator is used to perform a fixed-point division operation.

28. The speech coder of claim 27, wherein the fixed-point division operation includes taking an inverse of the denominator.

29. The speech coder of claim 28, wherein the inverse of the denominator is defined by the equation:
Divd=0x4000/n_{—}e,
wherein
Divd is the multiplication factor;
0x4000 is a hexadecimal representation of 0.5; and
n_e is the denominator, which represents a normalized and amplified value of a residue of the signal.

30. The speech coder of claim 29, wherein the multiplied numerator and multiplication factor are amplified.
